(19) United States
(12) Patent Application Publication
(10) Pub. No.: US 2009/0217840 A1
(43) Pub. Date: Sep. 3, 2009

(54) CELLULAR OR ORGANELLE-ENTRAPPED NANOPARTICLES

(75) Inventors: Ljiljana Kundakovic, Brookline, MA (US); Bruce Klitzman, Durham, NC (US); Kim Edward Koger, Tequesta, FL (US); Edith Mathiowitz, Brookline, MA (US); Craig A. Drill, New York, NJ (US)

Correspondence Address: FISH & RICHARDSON PC, P.O. BOX 1022, MINNEAPOLIS, MN, 55440-1022, US

(73) Assignee: FREEDOM-2, INC., Cherry Hill, NJ (US)

(21) Appl. No.: 12/064,223

(22) PCT Filed: Aug. 2, 2006
(86) PCT No.: PCT/US06/30037

§ 371 Date: Mar. 6, 2009

Related U.S. Application Data
(60) Provisional application No. 60/709,619, filed on Aug. 19, 2005.
(60) Provisional application No. 60/710,614, filed on Aug. 24, 2005.
(60) Provisional application No. 60/806,960, filed on Jul. 11, 2006.

(51) Int. Cl. C09D 11/00

(52) U.S. Cl. 106/31.03

(57) ABSTRACT

The invention provides tissue marking pigment or dye particle retained within a tissue cell, the cellular cytoplasm, or one or more intracellular organelles. Also, the invention provides nanoparticles, which are phagocytosed, engulfed or otherwise entrapped by cells.

This application claims the benefit of U.S. Provisional Patent Application No. 60/806,960, filed Jul. 11, 2006, U.S. Provisional Patent Application No. 60/710,614, filed Aug. 24, 2005, and U.S. Provisional Patent Application No. 60/709,619, filed Aug. 19, 2005. These provisional applications are incorporated herein by reference.

### BACKGROUND OF THE INVENTION

The present invention relates to entrapping nanometer-sized particles in cells, cellular cytoplasm and/or intracellular organelles. The present invention also relates to tissue markings, which utilize tissue cells, cellular cytoplasm or intracellular organelles as vehicle for entrapping the pigment or dye. Also, it relates to methods for preparing and removing such tissue markings.

Tissue markings, e.g., tattoos, have been used in almost every culture throughout history. They have been found on a five thousand year old human mummy, and decorated figurines suggest their use at least fifteen thousand years ago. Tattoos have been used for many purposes including identity, beauty, artistic and spiritual expression, medicine, and magic.

In the United States, official statistics are not kept on tattooing, but the practice has apparently been growing in popularity for the past few decades. The majority of tattoos are apparently obtained by people under forty years of age, including a significant proportion of teenagers. An estimated 2 million people are tattooed every year. A recent Harris Poll reported that 34 million Americans (16% of the population) have a tattoo. A recent national survey shows that the overall prevalence of tattoos among all U.S. adults is now 24%, peaking at 40% in the 25-30 year cohort. Approximately one-third had considered getting the tattoo removed, but none had opted to do so (probably because of perceived high cost, hassle, lack of efficacy, or side effects). This means that approximately 8% of the entire population has thought about getting a tattoo removed and decided against it for some reason.

In the United States today, tattoo uses include not only the familiar artistic tattoo, but also permanent makeup (for example, permanent eyebrows, eyeliner, lip liner, and lip color); corrective or reconstructive pigmentation (for example, repigmentation of scar tissue or areola reconstruction on mastectomy patients); medical markings (for example, marking gastrointestinal surgery sites for future monitoring or marling locations for radiation treatment); and identification markings on animals (for example, pedigree “tags” on purebred pets).

The tissue marling procedure traditionally consists of piercing the skin with needles or similar instruments to introduce ink that typically includes inert and non-soluble pigment particles having a wide distribution of sizes, which are suspended in a liquid carrier. Examples of machines typically used to apply a tattoo include an electromagnetic coil tattooing machine (such as that disclosed in U.S. Pat. No. 4,159,659 to Nightingale); a rotary permanent cosmetics application machine (such as that disclosed in U.S. Pat. No. 5,472,449 to Chou); or any manual tattooing device (such as the sterile single-use device marketed by Softap Inc., San Leandro, Calif.).

During the healing process, after tissue marking pigment has been applied, pigment particles can be affected in a variety of ways, many of which are detrimental to the appearance of the tissue marking. In particular, some small particles may readily diffuse and make the tissue marking blur. Other small particles may be taken up by the macrophages and phagocytes. Large particles may be removed from the implantation area directly through, for example, transdermal elimination, or sequestered in the extracellular matrix. Also, particles may be moved away from the implantation area to the lymphatic system.

Ultimately, what one sees as the tissue marking are the remaining particles of pigment located where they typically are engulfed by phagocytic skin cells (such as macrophages, phagocytes and fibroblasts) or are sequestered in the extracellular matrix. Transdermal elimination, diffusion and removal via the immune system tend to reduce the intensity and clarity of the tissue marking.

To create a permanent tattoo one must typically implant pigments that are not dissolved or digested by living tissue. Primitive pigments probably consisted of graphite and other carbon substances. Modern pigments also include inorganic metal salts and brightly colored organometallic complexes.

Tattoo ink ingredients have never yet been regulated or fully disclosed to the public. Ink composition and pigment sources remain trade secrets. Allergic reactions to these unknown and/or undisclosed substances, rare but in some cases severe, have been reported at the time of tattooing, well after the time of tattooing, and after exposure to sunlight or laser treatments.

The long-term health effects, including potential toxicity and/or carcinogenicity of tattoo pigments, have not been studied and are not known. Unfortunately, these pigments, chosen for their permanence, are believed to remain in the body for life, whether within the skin or in the lymph nodes. Even if the visible tattoo is “removed” or lightened from the marked area, for example, by laser treatment, the pigment may not be eliminated from the body.

A widely recognized problem with tattoos is that they cannot be easily removed. The above-mentioned recent Harris Pole estimates that about half of all Americans with tattoos would at some point wish they could remove them. Dissatisfaction can stem from undesired social disapproval; from the appearance of a tattoo that may be poorly executed, out-of-style, or inaccurate (commonly in the case of name-containing vow tattoos); or from changes in the wearer's self-perception or lifestyle. There is evidence that tattoo removal was an issue as early as the first century A.D. in Rome, when soldiers returned from barbaric regions with tattoos that were unacceptable to society.

Traditional tattoo “removal” methods include overtattooing without ink, dermabrasion, and surgical excision, all of which may leave an unacceptable appearance and/or scarring. One current tattoo removal method is treatment with Q-switched laser pulses, perhaps in the nanosecond-domain, which has been shown to remove tattoos with a low risk of scarring. A series of typically six to ten Q-switched laser treatments, which are expensive and usually cause discomfort, are administered at approximately one-month intervals. However, this method is generally inefficient and ineffective—only about 50% of tattoos are successfully removed in less than ten Q-switched laser treatments, and various wavelength lasers may be necessary to remove all of the types of ink used in a tattoo.

Q-switched laser treatment of tattoos is based on the concept of selective photothermolysis, in which a selectively-absorbed pulse of light is used to locally heat and destroy dermal cells containing the tattoo ink. After a laser treatment, some ink particles are naturally eliminated, for example, by the lymphatic system. Other ink particles, however, are re-phagocytosed by dermal cells, or otherwise remain in the skin as a residual tattoo, requiring re-treatment.

The majority of inks on the market today are, at best, of questionable safety. Tattoo inks are composed of ingredients that often include toxic heavy metals and organic dyes hazardous to human health. The above-mentioned laser “removal” of these materials may, in fact, create carcinogenic compounds, which are stored in the lymph nodes for the lifetime of the patient.

Recently, there has been proposed a new approach for providing both safe and more easily removable permanent tissue markings. Specifically, this approach involves encapsulating, complexing or aggregating tissue marking pigments or dyes in or as a vehicle prior to application to tissue, as described, for example, in U.S. Pat. No. 6,013,122 to Klitzman et al. and U.S. Pat. No. 6,814,760 to Anderson et al. The encapsulated pigment or dye may be selected such that it safely interacts with living tissue, and allows the use of pigments or dyes that otherwise could not be used in a traditional tissue marking. Such encapsulated, complexed or aggregated pigments or dyes may include, in addition to those conventionally used in the art, pigments or dyes that are dispersible or biodegradable in living tissue, or pigments that could cause an adverse reaction if placed directly into a living organism.

An additional advantage of such improved tissue markings is that they can be designed in advance to be susceptible to a specific type and amount of energy, which, when applied, ruptures or breaks apart the vehicle associated with the pigment or dye. Such a vehicle may, but not necessarily, include or contain a wavelength-specific discrete absorption component to assist in the rupturing or breaking apart of the vehicle. If the pigment or dye carried by the vehicle is readily dissolvable or dispersible in living tissue, rupturing or breaking apart the vehicle results in the substantial or entire removal of an otherwise permanent tissue marking. The design characteristics of the vehicle, pigment or dye, and/or the discrete absorption component govern the specific type and amount of energy necessary to eliminate a tissue marking, permitting accurate and efficient removal. This, in turn, mitigates some of the above-mentioned drawbacks of current removal methods, laser-based or otherwise.

Typically, to remove a permanent tissue marking prepared in accordance with U.S. Pat. Nos. 6,013,122 and 6,814,760, the amount of energy that needs to be applied to rupture the vehicle or otherwise release the pigment is relatively high. For example, sufficient force must be produced to overcome the integrity of the vehicle, which may be made from PMMA or another type of polymer. Even though such removal is expected to reduce the number and/or length of treatments, the amount of applied energy may still cause some undesirable discomfort, and a residual tissue marking may still remain. Therefore, additional improvements are desired to further increase patient comfort and improve removability.

Besides tissue marking, the use of a cell or its constituents to entrap nanoparticles may be beneficial, for example, in drug delivery or other medical therapeutic or diagnostic, biotechnology or pharmaceutical applications.

### SUMMARY OF THE INVENTION

To overcome the above-described deficiencies of the prior art, the present invention provides improved tissue markings and methods for implanting and removing them. Also, the present invention provides spheres, capsules or aggregates, which can deliver nanometer-sized particles to tissue cells so that these particles may be internalized by the cells.

In accordance with the present invention, the markings and/or any nanoparticle can be applied to any type of cell in an organism (either human or animal), which is capable of phagocytosing, absorbing or otherwise engulfing the nanoparticle. The cells include, but are not limited to, tissue cells in, skin, iris, sclera, muscles, tendons, organs, brain, small and large intestines, uterus, tumors and other cellular masses, legions, tissue beneath fingernails, tissue beneath toenails, tissue inside the mouth including the tongue, or tissue lining internal body passages. Most likely, the tissue is skim.

The present invention provides a tissue marking, which may be permanent, but removable on demand, wherein a cell, a cellular cytoplasm, or an intracellular organelle is used as a vehicle for retaining the pigment or dye. In the context of the present invention, permanent, but removable on demand, tissue markings are those that generally require an external application of specific energy to be removed.

In one aspect of the present invention, a permanent, but removable on demand tissue marking is made by using small, non-soluble pigment or dye particles. These particles are of such a size, that when they are in the interstitial (extracellular) space, they are readily eliminated by natural active or passive biological processes. Such pigment or dye particles are preferably of a size and/or physical characteristics that normally prevent them from being readily phagocytosed and retained by cells. These particles are temporarily chemically or physically modified in a way that encourages their phagocytosis, for example, by use of a short-term biodegradable material (e.g., polylactide, polyanhydride, or polyglycolide polymer or equivalents thereof) to bind them together temporarily, thereby causing the incorporation of the particles into the cell, for example, the cellular cytoplasm or one or more of the intracellular organelles, such as but not limited to, lysosomes, endosomes or golgi.

The pigment or dye particles, especially but not limited to pigment or dye nanoparticles, may be temporarily chemically altered to make them more readily phagocytosed by a variety of surface modifications, such as by changing their shape or by attachment of chemoattractant and pro-inflammatory molecules, including leukotrienes, cytokines or lipopolysaccharides, as disclosed in Provisional Application No. 60/587,864 and International Application No. PCT/US2005/024865. Alternatively, or in addition thereto, the pigment or dye nanoparticles may be temporarily physically modified to induce phagocytosis, such as by increasing their apparent particle size by grouping or adhering them together in microspheres, microcapsules or microaggregates. Equivalents of the above temporary chemical and/or physical modifications are within the scope of the present invention. For example, the pigment or dye nanoparticles may be polarized by electrical charge to cause them to attract and attach to each other on a temporary basis.

Once the modified pigment or dye nanoparticles have been phagocytosed and incorporated into the cell, cellular cytoplasm or intracellular organelle to create a tissue marking, the temporary chemical and/or physical modification substantially or fully degrades, dissolves, or otherwise is caused to cease to exist, leaving substantially or fully unmodified or disaggregated pigment or dye nanoparticles in the cell, the cellular cytoplasm or the intracellular organelle(s). The cell or the cellular cytoplasm or intracellular organelle(s) acts, in effect, as a stabilizing capsule for pigment or dye nanoparticles, preventing their elimination from the tissue. The pigment or dye nanoparticles remain entrapped in the cell, the cellular cytoplasm or the intracellular organelle(s) indefinitely, yielding a stable tissue marking.

When and if it is desired to remove the tissue marking or tattoo, the cell and/or its organelles can be lysed, releasing the pigment or dye nanoparticles into the interstitium where, because of their small size, they are eliminated by natural biological processes, thus effectively removing the tattoo.

The prior art encapsulations of U.S. Pat. Nos. 6,013,122 and 6,814,760, for the most part, required the pigment vehicle or microencapsulation to maintain its integrity for the intended duration of the tissue marking. In the present invention, however, the chemical and/or physical modification to the pigment or dye nanoparticles are advantageously temporary, and need only last long enough to induce phagocytosis and incorporation of the pigment or dye nanoparticles into the cell, cellular cytoplasm or intracellular organelle(s).

In another aspect of the present invention, certain pigment or dye nanoparticles aggregate to form spheres, capsules or aggregates of a size sufficient to result in phagocytosis without being modified. Examples of such pigments or dyes include iron oxide and beta-carotene. Preferably, these particles are from about 1 to about 20 nm, more preferably from about 5 to about 10 nm, in diameter.

Unlike the relatively high amount of energy needed to rupture prior art encapsulations, or otherwise release the pigments or dyes, the amount of energy required to remove the tissue marling in the present invention is lower, as it need only be sufficient to disrupt or lyse a cell. For example, the former may require a relatively high-powered laser, while the latter may only need a relatively low-power laser, or ultrasound. This results in a safer, easier to remove tissue marking. In addition, because the high concentration of cytotoxins contained in a lysosome may be sufficiently lethal to the cell, disruption of the lysosome alone, using even less energy, may be all that is necessary to release and eliminate the pigment or dye nanoparticles from the cell and thus remove the tissue marking. Less energy should result in fewer and/or shorter treatments and improve patient comfort.

Further, because dispersible pigment or dye particles are preferably used, they will more likely be eliminated by the tissue after the treatment. This should reduce the likelihood of residual tissue markings, thus desirably reducing the number of treatments and improving removability.

In other embodiments of the present invention, nanometer-sized particles other than pigments or dyes may phagocytosed, absorbed or otherwise engulfed or internalized by cells. These nanoparticles may include, but are not limited to, nanometer-sized encapsulations of other nanometer-sized materials. These nanoparticles may, but not necessarily, include drugs, therapeutic agents, DNA, RNA and other genetic material. DNA or RNA may be naturally occurring or engineered, such as cloned DNA, siRNA or microRNA. In addition, if the nanoparticles are made of a substance that can be activated, the present invention allows activation to occur once the nanoparticles are inside the cells. At least one nanoparticle may be used to form a microcapsule, microsphere or microaggregate as discussed herein in connection with pigment or dye nanoparticles, including the application of chemical and/or physical modification and/or immunomodulation.

As used herein, a “tissue marking” is any mark created by the introduction of the pigment into tissue, typically living tissue, with the intention of permanent or long-term endurance. Markings may be invisible or any visible color, and should be detectable, for example, by the naked eye or by using a detection device. Furthermore, the tissue marking may be such that it is not visible or detectible by a detection device until triggered by a specific event or exposed to a specific chemical or substance, such as a chemical, nuclear or biological weapon material.

As used herein, a tissue marking “pigment” or “dye” is broadly defined as a substance, which, upon implantation into tissue, can provide a tissue marking having diverse colors or appearance properties. The pigment can be comprised of graphite and other carbon substances. Also, the pigment can include inorganic metal salts and brightly colored organometallic complexes, etc.

In particular, the pigments or dyes that can be used in accordance with the present invention include, but are not limited to, various forms of carbon, metals, such as copper, silver and gold, metal oxides, such as iron oxides (yellow, red and black) and titanium dioxide, ultramarines any of the Food and Drug Administration (FDA) approved colorants (pigments, dyes and lakes) used commonly in foods, pharmaceutical preparations, medical devices, or cosmetics, such as copper-phthalocyanin, the well-characterized non-toxic aluminum and calcium salts FD&C Blue No. 1 Lake (Brilliant Blue FCF), FD&C Green No. 3 Lake (Fast Green FCF), FD&C Red No. 3 Lake (Erythrosine), FD&C Red No. 40 Lake (ALLLRA™ Red AC), FD&C Yellow No. 5 (Tartrazine) Lake, and FD&C Yellow No. 6 Lake (Sunset Yellow FCF), fluoran type colorants such as D&C Red No. 21 (Tetrabromofluorescin), D&C Red No. 27 (Tetrachlorotetrabromofluorescin) and D&C Orange No. 5 (Dibromofluorescin), indigoid type colorants, such as D&C Blue No. 6 (Indigo) and D&C Red No. 3 (Helindone Pink CN), anthraquinone colorants such as D&C Green No. 6 (Quinizarin Green SS) and D&C Violet No. 2 (Alizurol Purple SS), quinoline type colorants such as D&C Yellow No. 11 (Quinoline Yellow SS). Additional FDA approved dyes and colored drugs are described in the Code of Federal Regulations (CFR) for Food and Drugs (see Title 21 of CFR chapter 1, parts 1-99).

Furthermore, visibly colored near-infrared absorbing materials may be used as pigments or dyes to provide the desired detectable color or to contribute to the detectable color, if desired. The infrared-absorbing visible chromophore should be rendered invisible upon exposure of the microparticles to the radiation, for example, through dispersal. Examples of useful colored near-infrared absorbing materials include, but are not limited to, graphite and amorphous forms of carbon (black), iron oxides (black or red), silicon (black), germanium (dark gray), cyanine dyes (including indocyanine green and other colors), phthalocyanine dyes (green-blue), and pyrylium dyes (multiple colors), and the like, as disclosed in U.S. Pat. No. 5,409,797 to Hosoi et al.

In addition, variable appearance pigments or dyes as disclosed in U.S. Application Publication No. 2005-0172852 A1, such as, for example, frequency up-converting materials, may be used. Fluorescent (for example semiconductor nanoparticles, such as Quantum Dots), phosphorescent, and two photon absorption (TPA) materials may be used.

As used herein, a “tattoo” is a type of tissue marking wherein the tissue is usually, but not limited to, skin.

As used herein, “diameter” refers to a diameter of a spherical body, or to the largest linear dimension of a non-spherical body.

As used herein, “nanoparticle” with a diameter is a particle or a structure in the nanometer (nm) range, typically from about 1 to about 100 nm in diameter. Examples of a nanometer-sized structure in accordance with the present invention include, but are not limited to, nanoshells and nanometer-sized encapsulations (nanocapsules) of nanometer-sized materials.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and are not intended to be limiting.

The invention has numerous advantages over known tissue markings, as discussed above.

Other features and advantages of the invention are apparent from the following detailed description and from the claims.

### BRIEF DESCRIPTION OF THE DRAWINGS

FIGS. 1A-1D are schematic representations of a microsphere, microcapsule or microaggregate in accordance with the present invention. For simplification, several components of the tissue cell have been omitted.

FIGS. 2A-2C are schematic representations of pigment or dye nanoparticles phagocytosed by a tissue cell. For simplification, several components of the tissue cell have been omitted.

FIG. 3 is a chart showing an area of visible tattoos in accordance with the Experimental Example.

FIG. 4 is a chart showing an area of fluorescent tattoos in accordance with the Experimental Example.

FIG. 5 is a chart showing intensity of visible tattoos in accordance with the Experimental Example.

FIG. 6 is a chart showing intensity of fluorescent tattoos in accordance with the Experimental Example.

FIGS. 7A and 7B are images showing a histological appearance of tattoos a few hours after tattooing in accordance with the Experimental Example.

FIGS. 8A and 8B are images showing a histological appearance of tattoos 7 days after tattooing in accordance with the Experimental Example.

FIGS. 9A and 9B are images showing a histological appearance of tattoos 28 days after tattooing in accordance with the Experimental Example.

### DETAILED DESCRIPTION

The concept of a removable on demand tissue markings, such as a tattoo, according to the present invention includes a pigment or dye and a cellular vehicle encapsulating or containing the pigment or dye. The vehicle retains the pigment or dye and holds it stationary until it is desired for the tissue marking to be removed. Then, exogenous energy is applied causing the pigment to be released and eliminated by natural biological processes.

To require a relatively smaller amount of energy to be used for removal, as compared to conventional encapsulated pigments or dyes, in the present invention a cell, and in particular, cellular cytoplasm or intracellular organelle, such as a lysosome, an endosome, or golgi, or any combination thereof, is used as the vehicle to retain the pigment or dye nanoparticles.

The pigments or dyes used to form the nanoparticles may be, but need not be, soluble or digestible when in tissue. For a permanent tissue marking, it is preferable to use non-soluble and/or non-digestible pigments or dyes. In fact, one of the advantages of the presently claimed invention is that it allows the use of such pigments or dyes to form a permanent tissue marking, which can be removed on demand by applying a relatively low amount of energy.

In accordance with the present invention, the pigment or dye nanoparticles are of a size or have physical characteristics that prevent them from being readily phagocytosed and contained by cells on an individual basis. That is, because of their small size or physical characteristics, without, for example, a binding or other modifying agent, the released pigment or dye nanoparticles would be eliminated upon placement into the tissues of the body by natural biological processes. These nanoparticles are preferably from about 1 to about 100 nm, more preferably from about 1 to about 30 nm in diameter, and more preferably from about 1 to about 10 nm.

Such a small size can be achieved by using various known techniques, for example, laser gas synthesis or laser-liquid-solid interaction, as discussed in U.S. Pat. Nos. 6,068,800 and 5,770,126 to Singh. In addition, methods including chemical vapor deposition, physical vapor synthesis, hydrothermal methods, laser induced chemical vapor deposition, (co)-precipitation, sol-gel methods, and microemulsion methods may be used. A person skilled in the art will be able to determine which method is most suitable for a specific pigment or dye. The nanoparticles may also have physical characteristics, such as a particular shape or polarity, or chemical characteristics, which deter phagocytosis unless otherwise modified.

Typically, tissue does not have the same reaction to every particle implanted therein. The type of reaction, if any, generally depends both on the size of the implanted particle and the immune reaction thereto. For example, when a tissue marking is applied, some small particles readily diffuse. Many small particles, however, are taken up by the macrophages and phagocytes or are removed from the site into the lymphatic system. If, however, the tissue marking pigment or dye is selectively modified to be of a certain size or shape to heighten the immune system's response, the reaction of tissue to pigment or dye particles can be controlled to facilitate phagocytosis.

For example, cells can generally engulf particles that are smaller in size than the cells. Since, for example, skin cells are about five to thirty microns in size, they can readily engulf particles that are from about one to about five microns in diameter. Therefore, in order to promote phagocytosis, the pigment or dye nanoparticle size may be adjusted to be in that range, for example, by aggregating numerous nanoparticles.

The pigment or dye nanoparticles may be temporarily physically modified in a way that makes them larger as a group and encourages their phagocytosis, thereby leading to the incorporation of the pigment or dye nanoparticles into the cell, including, but not limited to, into the cellular cytoplasm or one or more intracellular organelles. The pigment or dye nanoparticles may also or alternatively be incorporated into other well-known cellular components. Specifically, the pigment or dye nanoparticles may be physically modified to induce phagocytosis by increasing their apparent particle size by adhering them together in spheres, capsules or aggregates, which are preferably, but not limited to, microspheres, microcapsules or microaggregates. The size of these microspheres, microcapsules or microaggregates may be used to induce phagocytosis. Preferably, substantially all or all pigment or dye particles in the microspheres, microcapsules or microaggregates are nanoparticles.

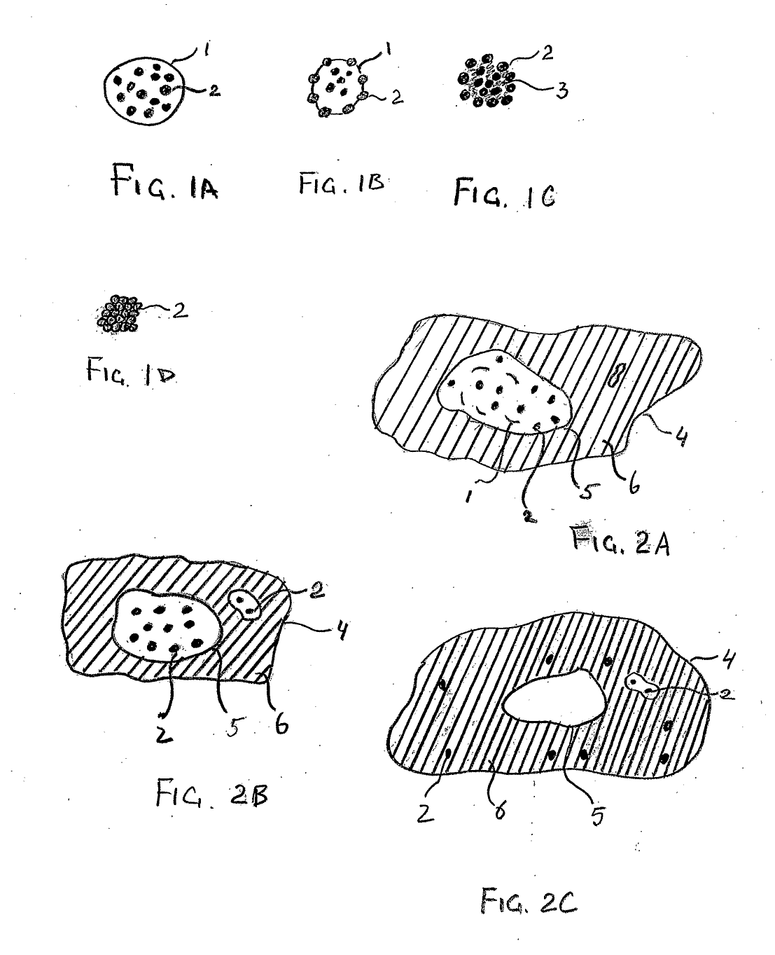

For example, as shown in FIGS. 1A and 1B, a microsphere or microcapsule 1 may encapsulate pigment or dye nanoparticles 2 and/or contain them in its structure. As shown in FIGS. 1C and 1D, a microaggregate may be formed from pigment or dye nanoparticles 2, which are adhered, aggregated or otherwise joined together. Typical materials 1 and 3, which can, for example, bind, encapsulate or otherwise complex with the pigment or dye nanoparticles for their temporary, phagocytosis-inducing modification may include well-known biodegradable materials, which preferably have adhesive properties, for example, biodegradable polymer compounds, such as polycaprolactones.

Besides aggregation via a binding agent, the pigment or dye nanoparticles may be physically modified by changing their shape, again to induce phagocytosis. Also, the pigment or dye nanoparticles may be electrically charged to cause them to attract and bind to each other.

In addition to, or instead of, physical modification, the pigment or dye nanoparticles may be chemically altered to make them more readily phagocytosed by attaching chemoattractant and pro-inflammatory molecules including leukotrienes, cytokines or lipopolysaccharides. Further, the pigment or dye nanoparticles may be immunomodified in accordance with the disclosure in Provisional Application No. 60/587,864 and International Application No. PCT/US2005/024865, so that nanoparticles that are outside the typically engulfable size range may be internalized by organelles.

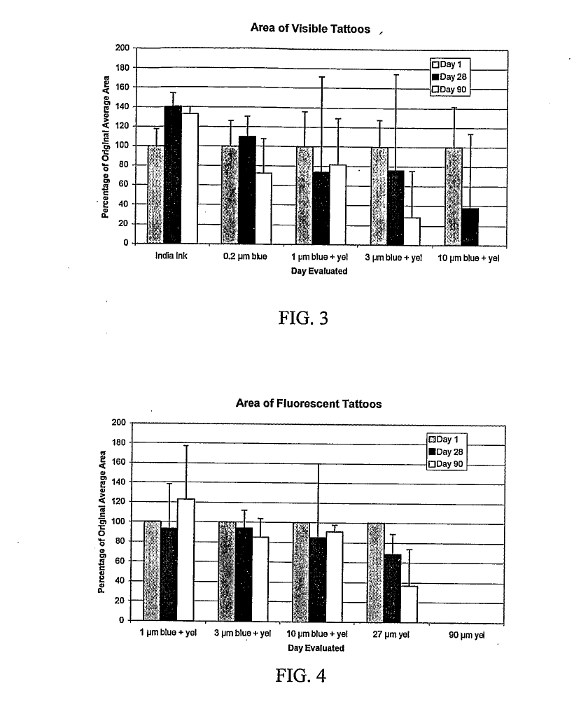

The microspheres, microcapsules or microaggregates that are formed for phagocytosis by tissue cells preferably spontaneously degrade, erode, are absorbed, dissolve or otherwise break apart within the cell, cell organelle and/or the cytoplasm, thereby releasing the pigment or dye nanoparticles inside the cellular cytoplasm and/or intracellular organelles, as shown in FIGS. 2A-2C. The cell 4, or in particular, the organelle 5 and/or cytoplasm 6 of the cell 4 that phagocytosed the microspheres, microcapsules or microaggregates, thus retains the pigment or dye nanoparticles 2.

The microcapsules, microspheres, microaggregates or the like, in accordance with present invention, may be formed from a variety of binding agent materials, which allows them to bind and then release the pigment or dye nanoparticles within the cell, cytoplasm or organelle(s). One type of such material is a bioabsorbable, bioerodable or biodegradable polymer. A great many biodegradable polymers exist, and the length of time that the nanoparticles stay bound together is determined by controlling the type of material and composition of the microcapsule, microsphere or microaggregate.

For example, the bioabsorbable, bioerodable, or biodegradable polymers disclosed in U.S. Pat. Nos. 3,981,303; 3,986,510 and 3,995,635 to Higuchi et al. may be used as binding agents, including zinc alginate poly(lactic acid), poly(vinyl alcohol), polyanhydrides, and poly(glycolic acid). Preferred polymers include poly-L-lactic acid (PLLA), poly D-lactic acid (PLDA) and poly-lactic-glycolic acid (PLGA). These preferred polymers may used to form microsphere, microcapsules or microaggregates, which include pigment or dye particles, such as iron oxide (5-10 nm and 20-30 nm in diameter), gold, silver, and titanium dioxide. For example, iron oxide nanoparticles from about 5 to about 10 nm in diameter may be encapsulated by PLLA, resulting in a rust-colored tissue marking. Higher concentrations of iron oxide nanoparticles may result in brown and black-colored tissue markings.

Alternatively, microporous polymers are suitable as binding agents, including those disclosed in U.S. Pat. No. 4,853,224 to Wong, such as polyesters and polyethers, and U.S. Pat. Nos. 4,765,846 and 4,882,150 to Kaufman. A particularly preferred bioabsorbable polymer vehicle is a triblock copolymer of poly caprolactone-polyethylene glycol-poly caprolactone. This polymer contains ester bonds, which hydrolyze in a hydrophilic environment.

Microaggregates are formed by inducing the pigment or dye nanoparticles to join together in a complex of a size that triggers phagocytosis. Nanoparticles may be, for example, bound together using a biodegradable adhesive. Such an adhesive preferably degrades or otherwise loosens the aggregate, releasing the nanoparticles once inside the cell, cytoplasm or organelle(s). This is typically accomplished by using polymers that hydrolyze when in a biological environment, such as polylactide.

Also, in an alternative embodiment, an enzyme may be included in the microspheres, microcapsules or microaggregates to affect the release of the pigment or dye nanoparticles in the cell, cytoplasm or organelle(s). The enzyme is selected to degrade the microspheres, microcapsules or microaggregates to a point at which they can no longer maintain their integrity and the nanoparticles are released. An example of such a system is an ionically cross-linked polysaccharide, calcium alginate, which is ionically coated with a polycationic skin of poly-L-lysine. The enzyme used to degrade the calcium-alginate coated with poly-L-lysine microcapsules is an alginase from the bacteria Beneckea pelagio or Pseudomonas putida. Enzymes exist that degrade most naturally-occurring polymers. For example, the pigment encapsulate may be formed of chitin for degradation with chitinase. Other natural or synthetic polymers may also be used and degraded with the appropriate enzyme, usually a hydrogenase.

Once the modified pigment or dye nanoparticles are phagocytosed and incorporated into the cell, cytoplasm or organelle(s), the temporary modification substantially or fully degrades, dissolves or otherwise ceases to exist, leaving the original, disaggregated pigment or dye nanoparticles in the cells, cytoplasm or organelle(s), thereby creating a tissue marking or tattoo, as shown, for example, in FIGS. 2A-2C. The cell, cytoplasm or organelle(s) prevents the substantial elimination of the nanoparticles retained therein, at least until a particular external energy source is applied. Thus, the disaggregated pigment or dye nanoparticles remain, for the most part, entrapped in the cell, cytoplasm or organelle(s) indefinitely, yielding a stable tissue marking.

While the temporary modification may be designed to degrade, dissolve or otherwise ceases to exist by natural biological processes after phagocytosis, the modification may also be designed so that it can be disrupted to leave the original, disaggregated pigment or dye nanoparticles in the cells, cytoplasm or organelle(s) by applying exogenous energy, which is insufficient to cause a release of the nanoparticles from the cell. For example, if the pigment or dye nanoparticles were aggregated by altering their polarization to cause them to be attracted to each other, a magnetic or electric field may be externally applied to disaggregate the nanoparticles inside the cell without releasing the nanoparticles from the cell.

Furthermore, some pigment or dye nanoparticles that can aggregate to form spheres or aggregates of a size sufficient to result in phagocytosis without any additional modification may also be used in the tissue marking ink in accordance with the present invention. Such spheres or aggregates may be represented by a schematic shown in FIG. 1D, which also represents spheres or aggregates of modified nanoparticles.

Examples of the pigment or dye particles that can form spheres or aggregates without modification, for example chemical or physical modification as discussed above, include iron oxide and beta-carotene. Preferably, these nanoparticles are from about 1 to about 20 nm, more preferably from about 5 to about 10 nm, in diameter. Further, the nanoparticles are preferably substantially uniform in their size distribution. These nanoparticles may also be modified as discussed above.

When and if it is desired to remove the tissue marking or tattoo, the cell and/or its organelles are lysed via application of exogenous energy or as otherwise discussed below, releasing the pigment or dye nanoparticles into the interstitium where, because of their small size or other physical characteristics, they are eliminated by natural biological processes.

It is possible that some of the pigment or dye nanoparticles may spontaneously aggregate either before or after being released from lysed organelles when such aggregation is not desired. If the aggregates are sufficiently large, lysing or otherwise disrupting the organelles to release the pigment or dye nanoparticles may not completely remove the tissue marking, because these aggregates may be large enough to be re-phagocytosed by another organelle, creating an undesirable residual tissue marking. To address this, the pigment particles may be modified prior to implantation in tissue to resist spontaneous aggregation that could otherwise trigger re-phagocytosis. This modification can be accomplished, for example, by electrically charging (polarizing) the nanoparticles to cause them to repel each other, or by coating them with materials, such as polyethylene glycol, that would resist such aggregation.

In order to prepare tissue marking ink for implantation, at least one microsphere, microcapsule or microaggregate containing at least one pigment particle is prepared, as discussed above. This microsphere, microcapsule or microaggregate is such that it is capable of triggering phagocytosis by a tissue organelle and also capable of releasing the particle once phagocytosed by the organelle.

The ink preferably includes a carrier for the microsphere, microcapsule or microaggregate. Any conventional carrier, such as such as ethanol or water, or any other conventional tattooing ink fluid, may be in a concentration sufficient to produce the desired tissue marking. Alternatively, the microsphere, microcapsule or microaggregate may be in the form of a suspension in a semi-liquid paste, similar to that used to prepare conventional tissue markings.

The tissue marking ink may be prepared such that at least about 50%, preferably at least about 70%, more preferably at least about 80%, still more preferably at least about 90%, of the particles therein, such as microspheres, microspheres or microaggregates discussed above, are from about 0.2 to about 100 microns in diameter, more preferably from about 1 to about 10 microns in diameter, and still more preferably from about 1 to about 3 microns in diameter. In addition, in yet another embodiment of the present invention, the particles may be, for example, conventional pigment or dye microparticles, such as India Ink microparticles, or encapsulates or aggregates as disclosed in U.S. Pat. Nos. 6,013,122 and 6,814,760 and U.S. Patent Application Publication No. 2005-0172852 A1.

The microparticles may be screened using molecular sieves or any other commonly known method in order to prepare the ink containing the desired particle size distribution. This selection process may be carried our before or after the particles are combined with the carrier. The particles that are larger than about 100 microns, preferably larger than 10 microns, preferably larger than 3 microns, are removed or discarded, to result in a high density of small-sized microparticles.

The reasons for selecting particles within the above-mentioned size ranges are discussed below in the Experimental Example. Although the microparticles in the following Experimental Example did not contain nanoparticles of pigments or dyes, the results regarding the desirability of relatively small-sized microparticles is equally applicable to microparticles that do contain pigment or dye nanoparticles that were discussed above.

### Experimental Example

A study was conducted to determine the effects of microparticle size on tattoo appearance, distribution and skin responses to tattoos made with colored and fluorescent polystyrene microparticles ranging from 0.2 to 90 μm in diameter. Gross and microscopic observations of the particles' distribution, tattoo appearance and skin responses were performed and compared to conventional tattoo ink (India Ink, particle size <1 μm).

Experimental Design:

Sixteen male hairless rats, 6-8 weeks of age were used to test the biodistribution of biomaterials applied cutaneously as tattoos. Seven markings, each 1-2 cm in length and 3-5 mm in width were created on each rat using a standard tattooing device, as summarized in Table 1. For tattoo application, equal volumetric fractions of blue colored and fluorescent polystyrene microspheres (Polysciences, Warrington, Pa.) were mixed. Concentration of microspheres in the water dispersion was 2.5% (v/v). The rats were allowed to recover and placed into cages for routine care. The rats were monitored by a veterinary on-site for signs of infection or other clinical problems for the duration of study.

Digital photos of tattoos and calibration scale were taken on day 4, day 7, day 28 and day 90. One subset of four rats was sacrificed at each of three different time points: day 0, day 7, day 28 and day 90. Full thickness skin biopsies were taken immediately after euthanizing each rat for histological analysis. On day 28 and 90, lung, liver, heart and spleen were harvested and fixed for histological analysis.

| | Tattoo ink | Particle size | |
|---|---|---|---|
| Marking 1 | Polybead Polystyrene Blue Dyed | 0.2 | μm |
| Marking 2 | Polybead Polystyrene Blue Dyed; | 1.0 | μm |
| | Fluoresbrite YG | | |
| Marking 3 | Polybead Polystyrene Blue Dyed; | 3.0 | μm |
| | Fluoresbrite YG | | |
| Marking 4 | Polybead Polystyrene Blue Dyed; | 10 | μm |
| | Fluoresbrite YG | | |
| Marking 5 | Polybead Clear Polystyrene; Fluoresbrite YG | 27 | μm |
| Marking 6 | Polybead Clear Polystyrene; Fluoresbrite YG | 90 | μm |
| Marking 7 | India Ink (black) | <1 | μm |
| (Control) | | | |

Experimental Groups

Image Analysis:

All image analysis was conducted using ImageJ 1.32j, a public domain image analysis program developed by the NIH. Each image of excised skin was decomposed into red, green, and blue channels; the red channel was analyzed for images taken with visible light and the green channel was analyzed for fluorescent images. These channels were chosen to emphasize the contrast between background skin and tattoo; in some channels (the blue channel for both visible and fluorescent light, and the red channel for fluorescent light) there was little or no difference between the tattooed area and the surrounding skin. The brightness and contrast was adjusted to account for lighting differences between images (visible light images only) so that the middle gray color on the reference strip had a brightness of 128 (on a scale of 1-256) and the contrast appeared appropriate. The brightness and contrast of the fluorescent images was not adjusted because no reference strip was included in the images.

Images from days 1, 28, and 90 were analyzed. The day 7 images did not have reference strips. The size of scale bars for tattoos on the fluorescent images were calculated by comparing distinct features on the excised skin in the fluorescent and visible images. After each tattoo was selected using the polygon selection tool, the area (in pixels) and the average intensity of the selection were recorded. The area was normalized by dividing by the square of the number of pixels in length of a section of the reference strip. The intensity of the tattoos was normalized by subtracting the intensity of the nearby, non-tattooed skin.

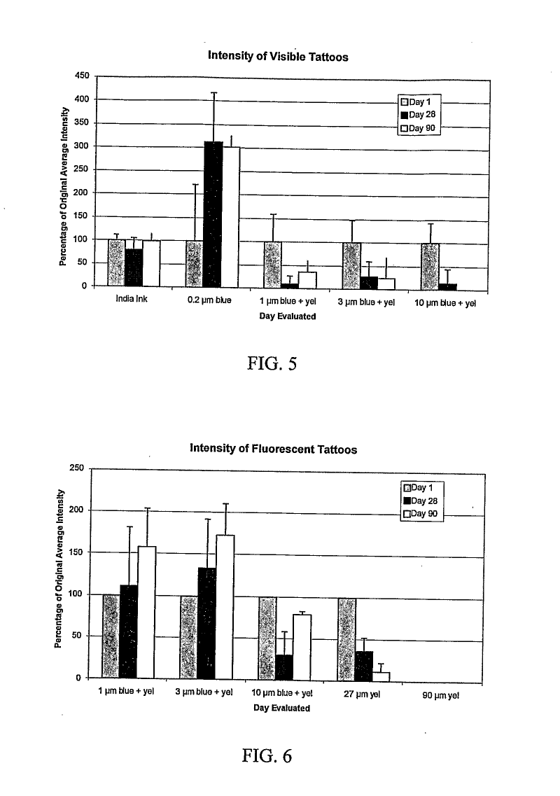

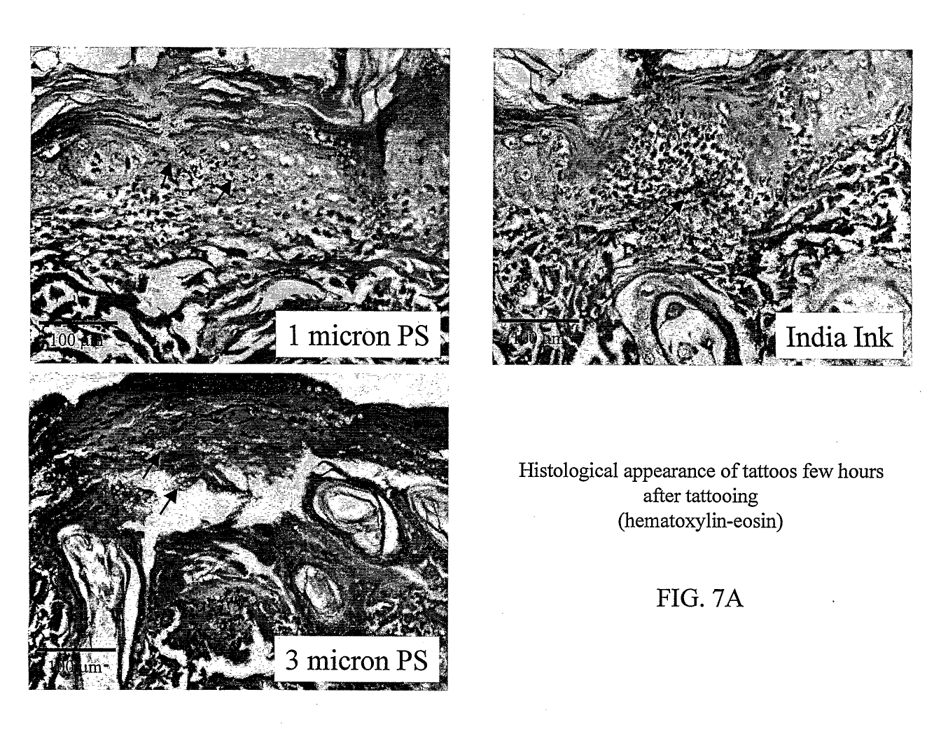

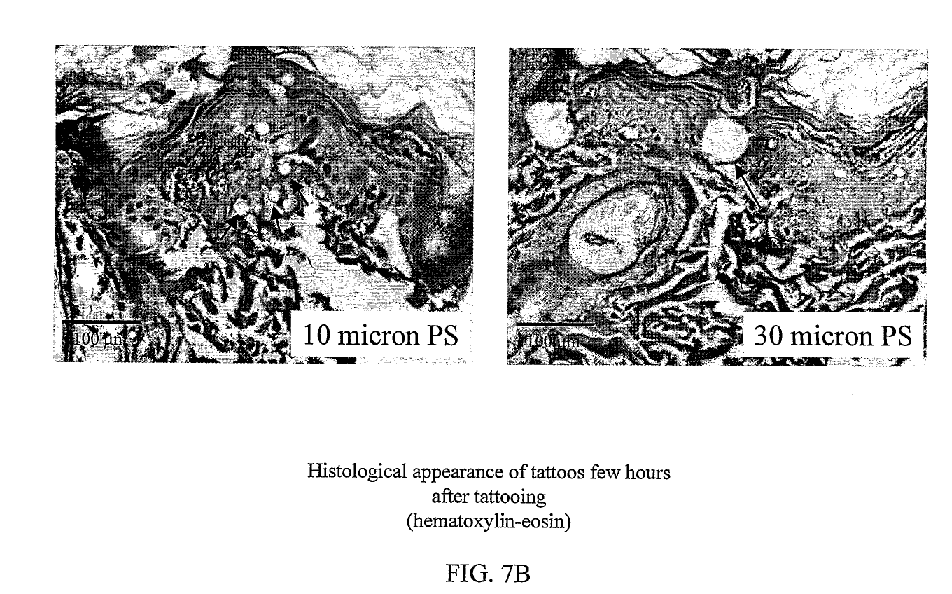

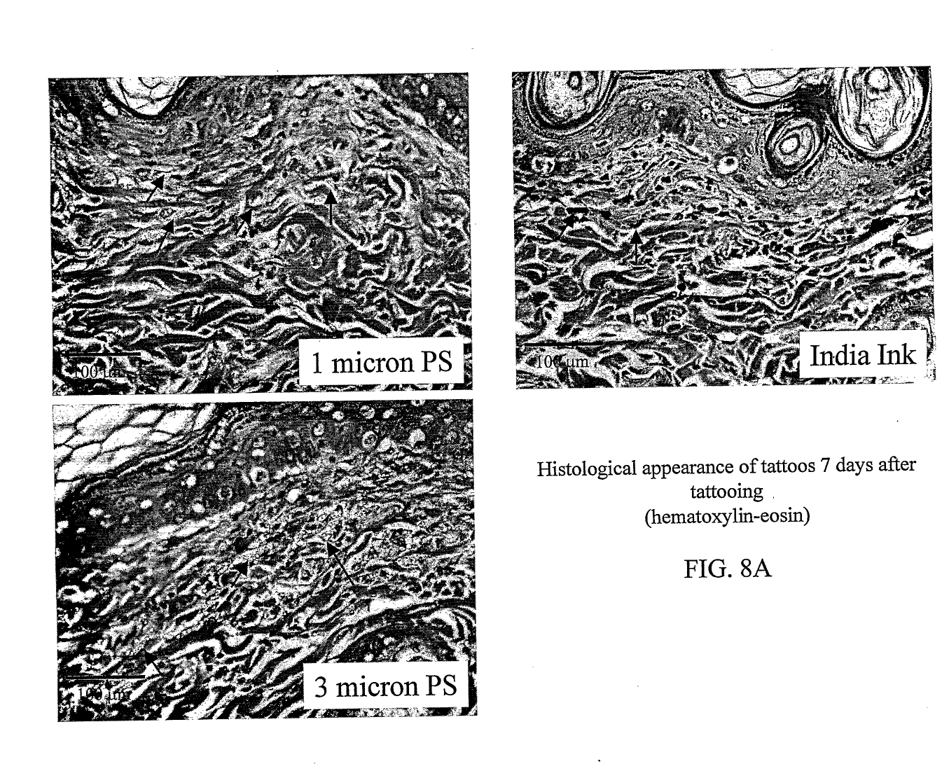

There was a large variability in the intensity and area of tattoos within subgroups, but certain trends could still be identified, as shown in FIGS. 3-6. Tattoo area showed a small decrease with longer implantation time for particles smaller than 3 μm. The area of the of the tattoos made with 10 and 30 micron particles decreased significantly during a three-month period.

Similarly, smaller pigment particles made better tattoos with stronger intensity. Tattoo intensity decreased with time for most pigments except the India ink standard and the smallest (0.2 μm) particles, particularly over the first 28 days. Visible and fluorescent analysis of tattoos with both inks showed the same trends but not exact correspondence.

Intensity of fluorescent tattoos at 28 and 90 days was generally higher than intensity of visible tattoos, especially for larger particles. The intensity of tattoos in the skin is determined by the absorption coefficient of the ink particles and particle number density in the skin. The decrease in the intensity of visible tattoos made with larger particles is in part due to the significantly smaller initial particle number density in these inks. For example, number of particles in the ink containing ten-micron particles is 1000 times lower than the number of particles in the ink containing one-micron particles. Additionally, the skin better retained smaller particles.

Histological Evaluation:

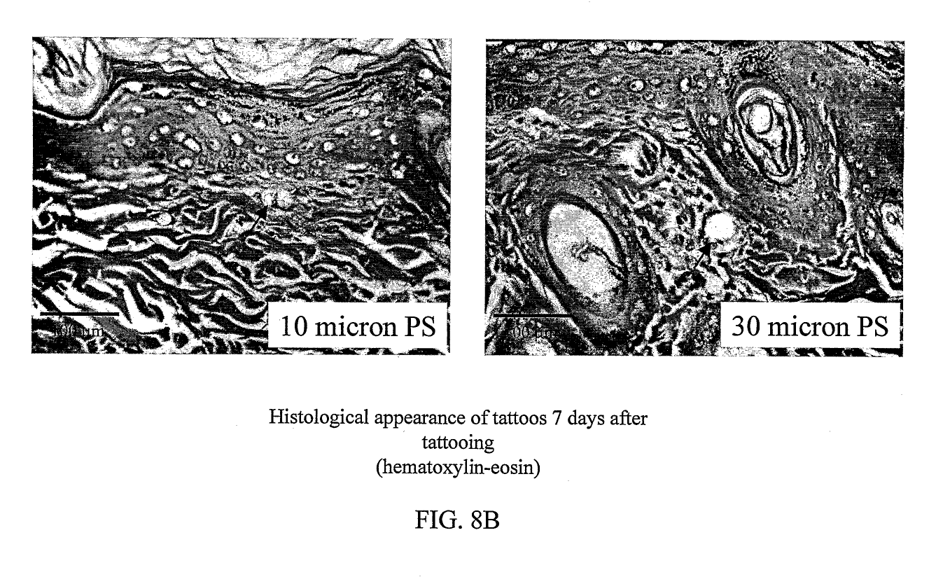

A few hours after tattooing, both polystyrene and India Ink particles were mainly distributed in the upper dermis, as shown in FIGS. 7A and 7B (the arrows indicate the location of tattoo particles). Ink particles (both polystyrene and India Ink) were partially exuded from the skin immediately after tattooing and during healing period. One and three-micron particle distribution was similar to India Ink control.

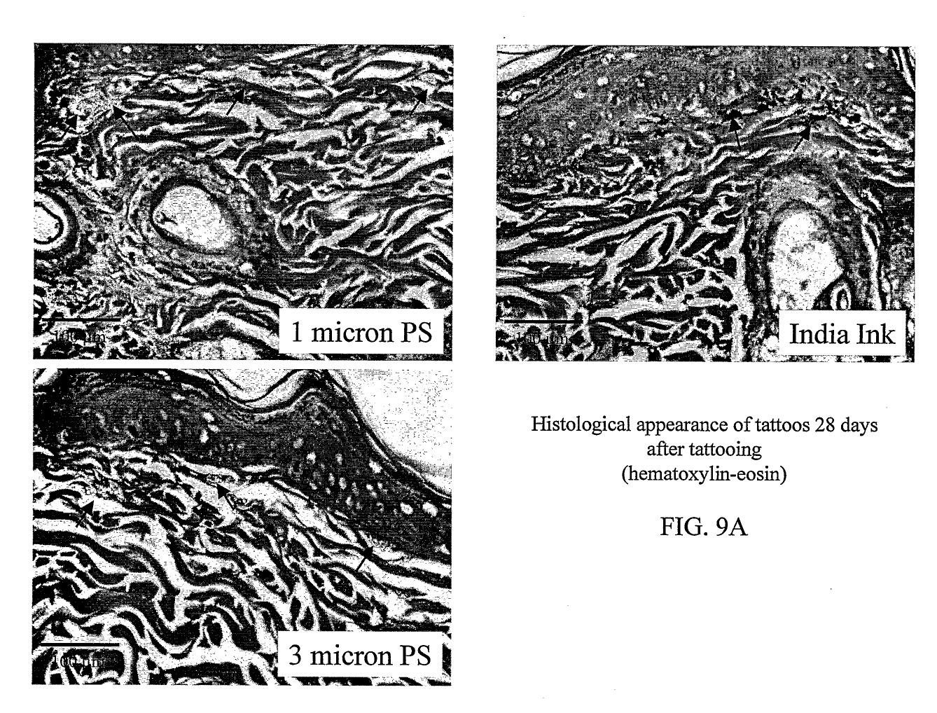

One week following tattooing, there was a predominance of ink particles in the upper dermis in the middle reticular dermis, as shown in FIGS. 8A and 8B (the arrows indicate the location of tattoo particles). Smaller particles (0.2, 1, 3 and 10 microns) appear to be phagocytosed by dermal cells. The distribution of 0.2, 1 and 3 micron particles was similar to India Ink. Mild inflammation was evident for all inks.

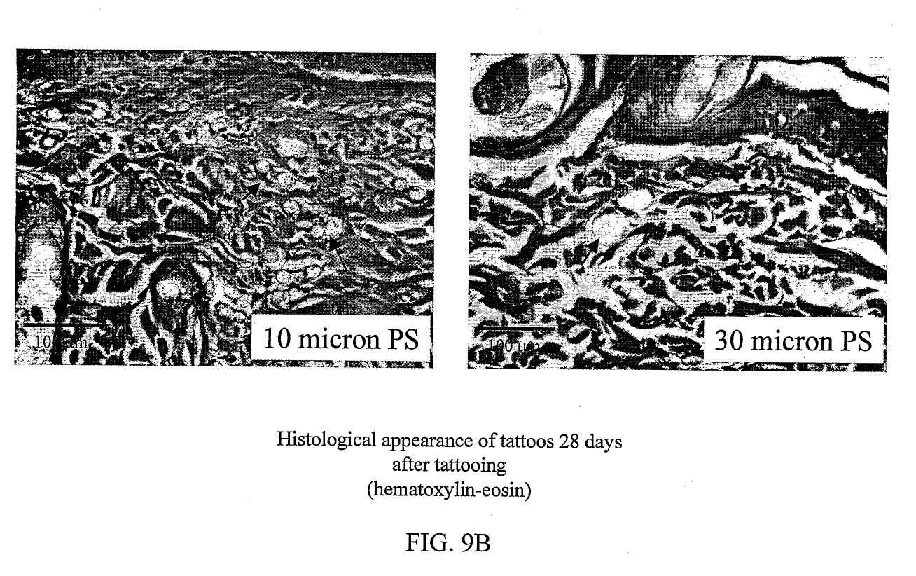

At 28 and 90 days, particles smaller than ten microns showed clumping and a distribution consistent with phagocytosis, as shown in FIGS. 9A and 9B (the arrows indicate the location of tattoo particles). India Ink, 0.2, 1 and 3 micron particles appear to be phagocytosed and migrated to a perivascular distribution like that of India Ink. Ten-micron particles showed clumping and a distribution consistent with phagocytosis. Ink particles were mainly distributed in the upper dermis and occasionally found in the middle reticular dermis. Mild inflammation was still evident for tattoos made with ten and thirty micron particles. Thirty-micron particles induced formation of small granulomas. Tattoo ink distribution did not change significantly between 28 and 90 days.

Overall, particles smaller than ten microns appear to be phagocytosed and were distributed in the skin similar to control India Ink. Smaller particles were also better retained in the skin and made better tattoos. Intracellular location of tattoo ink particles has still to be confirmed by electron microscopy.

There was a large variability in the intensity and area of tattoos within subgroups, but certain trends could still be identified. Tattoo intensity decreased with time for most visible tattoos except the India Ink standard and the smallest (0.2 μm) particles, particularly over the first 28 days. Fading of tattoos occurred primarily during the healing period and can be in part attributed to the transdermal elimination of ink particles. Smaller blue-colored and fluorescent particles (0.2, 1, and 3 μm) made better tattoos and retained good contrast over 90 days. The 90 μm particles were eliminated by the skin immediately after application and were completely unsuccessful. Fluorescent and visible analysis of tattoos with both inks showed the same trends but not exact correspondence.

There was no significant blurring (change in the area of the tattoo) of tattoos made with 0.2, 1, 3 μm particles. Tattoo area showed a small decrease with longer implantation time, indicating insignificant migration of the ink during the 3 months period. Tattoos made with 10 and 30 μm particles faded and their area decreased in the first 28 days.

The distribution of smaller particles (0.2, 1, and 3 μm) in the skin was similar to the distribution of India Ink (<1 μm). Smaller particles (0.2, 1, 3 and 10 μm) appear to be phagocytosed within first 7 days following tattooing. There was a predominance of ink particles in the upper dermis and middle reticular dermis. The 30 μm particles induced formation of small granulomas (days 7-90). No clinical problems or adverse effects on the animal health were observed for the duration of the study.

For the purposes of the present invention, larger microparticles, such as those larger than 30 microns in diameter, may be immunomodified in accordance with Provisional Application No. 60/587,864 and International Application No. PCT/US2005/024865 in order to facilitate phagocytosis, if necessary.

The tissue marking ink in accordance with the present invention may be implanted to form a tissue marking in accordance with conventional tattooing methods.

The tissue marking may be removed by disrupting the cell and/or organelle(s) housing the pigment particle by using exogenous energy to release the pigment. Examples of such energy include thermal, sonic (including ultrasonic, audible, and subsonic), light (including laser light, infrared light, or ultraviolet light), electric, magnetic, chemical, enzymatic, mechanical (such as shear force from rubbing or massaging), radiofrequency, or any other type of energy or combination of energies. As stated above, the amount of energy used to lyse the cell or organelle, or both, is generally less than that used to remove prior art encapsulated pigments or dyes.

In addition to providing a tissue marking in which pigment or dye nanoparticles are encapsulated by tissue cells, cellular cytoplasm or intracellular organelles, the present invention also encompasses nanoparticles other than pigments or dyes internalized by cells or their constituents. This may be accomplished by substituting pigment or dye nanoparticles discussed above with other types of nanoparticles, such as pharmaceutical or therapeutic agents, stem cells, vaccines, DNA, RNA and other genetic material.

DNA or RNA may be naturally occurring or engineered, such as cloned DNA, siRNA or microRNA. Vaccines may be used for preventative, therapeutic or any other suitable purpose. For example, a flu vaccine may be delivered in the same fashion as pigments or dyes discussed above.

Also, the immune system reacts differently to vaccines and drugs delivered to the skin rather than intramuscularly. For example, the same dosage of a vaccine may be more efficacious when delivered to the skin rather than intramuscularly, because of the immune reaction. Therefore, if there is a shortage of a particular vaccine, it may be incorporated into the sphere, capsule or aggregate in accordance with the present invention and delivered into the skin in a smaller dosage than would be required for an intramuscular injection. This would allow rationing of the vaccine to a larger segment of the population without compromising its efficacy.

In addition, a sphere, capsule or aggregate in accordance with the present invention can also be used to deliver compounds that ordinarily result in an undesirable immune system reaction, thereby increasing tolerance. Specifically, these compounds would not be recognized by a cell until they are engulfed and the nanoparticles are released.

Furthermore, if the nanoparticles are made of a substance that can be activated, the present invention allows activation to occur once the nanoparticles are inside the cells. Like pigment or dye nanoparticles discussed above, these nanoparticles may be combined to form a microsphere, microcapsule or microaggregate to facilitate internalization by cells.

Immunomodulation may be used to make phagocytosis, engulfment or other internalization of the microspheres, microcapsules or microaggregates more likely, and may be used to target the nanoparticles to specific types of cells or receptors. Implantation or delivery of these microspheres, microcapsules or microaggregates may be achieved by injection, by ingestion, transdermally, intravenously, or by using any other conventional delivery means.

As with pigments or dyes, the materials constituting these nanoparticles may have various properties. These materials may, for example, be dissolvable, digestible, dispersible, as well as non-soluble, non-digestible or non-dispersible. Further, the nanoparticles may be released from the cell or its constituents by lysing the cell, as discussed above.

While the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A sphere, capsule or aggregate comprising at least one pigment or dye particle,
wherein the pigment or dye particle is from about 1 to about 100 nm in diameter, and
wherein the sphere, capsule or aggregate is capable of being phagocytosed by a tissue cell, and releasing the pigment or dye particle into the tissue cell upon or after phagocytosis.

2-6. (canceled)

7. The sphere, capsule or aggregate according to claim 1, wherein the pigment or dye particle is from about 1 to about 10 nm in diameter.

8-14. (canceled)

15. The sphere, capsule or aggregate according to claim 1, further comprising one or more biodegradable or bioabsorbable material to bind pigment or dye particles.

16-24. (canceled)

25. The sphere, capsule or aggregate according to claim 1, further comprising a compound on its outer surface, which said compound increases protein adsorption to the outer surface.

26. The sphere, capsule or aggregate according to claim 1, further comprising on its outer surface molecules that interact with specific receptors on a surface of the tissue cell to heighten aggressiveness of an immune system reaction to the sphere, capsule or aggregate.

27. The sphere, capsule or aggregate according to claim 26, wherein the molecules are selected from the group consisting of integrins, endotoxin, lipopolysaccharide and any combination thereof.

28. The sphere, capsule or aggregate according to claim 25, wherein the compound is covalently or ionically bonded to the outer surface.

29. The sphere, capsule or aggregate according to claim 25, wherein the compound is a lipopolysaccharide.

30. The sphere, capsule or aggregate according to claim 29, wherein the lipopolysaccharide is obtained from E. coli or Porphyromonas gingivalis.

31. The sphere, capsule or aggregate according to claim 25, wherein the compound is a cytokine.

32. The sphere, capsule or aggregate according to claim 31, wherein the cytokine is TNF-α.

33. The sphere, capsule or aggregate according to claim 25, wherein the compound is a leukotriene.

34. The sphere, capsule or aggregate according to claim 33, wherein the leukotriene is LTB4.

35-84. (canceled)

85. A method for forming a sphere, capsule or aggregate comprising:
forming at least one pigment or dye particle that is from about 1 to about 10 nm in diameter; and
combining said pigment or dye particle to form the sphere, capsule or aggregate,
wherein the sphere, capsule or aggregate is capable of being phagocytosed by a tissue cell, and releasing the pigment particle into the tissue cell upon or after phagocytosis.

86-93. (canceled)

94. The method according to claim 85, wherein pigment or dye particles are combined to form the sphere, capsule or aggregate using at least one biodegradable or bioabsorbable material to bind the pigment or dye particles.

95-104. (canceled)

105. The method according to claim 85, further comprising a step of providing on an outer surface of the sphere, capsule or aggregate molecules that interact with specific receptors on a surface of the cell to heighten aggressiveness of an immune system reaction to the sphere, capsule or aggregate.

106. The method according to claim 105, wherein the molecules are selected from the group consisting of integrins, endotoxin, lipopolysaccharide and any combination thereof.

107-130. (canceled)

131. A tissue marking ink comprising particles in a carrier, wherein at least 50% of the particles are from about 0.2 to about 100 microns in diameter.

132-134. (canceled)

135. The tissue marking ink according to claim 131, wherein at least 50% of the particles in the ink are from about 1 to about 10 microns in diameter.

136. (canceled)

137. The tissue marking ink according to claim 131, wherein the particles, which are from about 1 to about 3 microns, comprise a sphere, capsule or aggregate comprising at least one pigment or dye particle, which is from about 1 to about 10 nm in diameter.

138-160. (canceled)
